(19) United States
(12) Patent Application Publication
(10) Pub. No.: US 2020/0133309 A1
(43) Pub. Date: Apr. 30, 2020

(54) BEACH CLEANING AUTONOMOUS ALL-TERRAIN VEHICLE SYSTEM AND METHOD

(71) Applicant: Honda Motor Co., Ltd., Tokyo (JP)

(72) Inventors: Jason W. GRUNDEY, Wapakoneta, OH (US); Richard M. LOWERY, JR., London, OH (US); Naoki MURASAWA, Dublin, OH (US)

(21) Appl. No.: 16/177,041

(22) Filed: Oct. 31, 2018

(51) Int. Cl. G05D 1/02; G05D 1/00; G06K 9/00

(52) U.S. Cl. CPC G05D 1/0295; G05D 1/0088; G05D 1/0289; G05D 1/0238; G05D 2201/0203; G05D 1/0246; G05D 1/0278; G05D 1/0225; G06K 9/00805

(57) ABSTRACT

A system and method for cleaning a beach includes a master autonomous vehicle that includes a controller, a camera, a GPS unit, a ranging unit, and a wireless communication unit. The system further includes at least one client autonomous vehicle in wireless communication with and operated by the controller of the master autonomous vehicle and a plurality of beach cleaners attached to the autonomous vehicles. The autonomous vehicles may detect and avoid obstacles on the beach being cleaned and each other.

### TECHNICAL FIELD

The embodiments disclosed herein are related to the field of autonomous vehicles, and more particularly when used with a system and method for cleaning beaches or sandy areas.

### BACKGROUND

An autonomous vehicle is an unmanned vehicle that is generally capable of sensing its environment and navigating without input from a driver. An autonomous vehicle may perform autonomous driving by recognizing and determining surrounding environments through various sensors attached to the autonomous vehicle. Further, an autonomous vehicle may enable a destination to be set and move to the set destination via autonomous driving.

Various garbage such as fragments of fishing nets, ropes, vinyl cords, paper waste, chips of wood, empty cans, bottles, plastic bottles, caps of the plastic bottles, cigarette ends, etc. scatters on a sand beach such as a swimming beach or the like. A beach cleaner runs on the sands while pulled by a vehicle with a scraper biting into the sands, whereby relatively small garbage or stones can be scraped up together with the sand and collected on a mesh member.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a system for cleaning a beach includes a master autonomous vehicle that includes a controller for operating the master autonomous vehicle, a camera in communication with the controller for supplying image data to the controller, a global positioning satellite unit for determining a position of the master autonomous vehicle, a ranging unit for determining a distance to an obstacle from the master autonomous vehicle in communication with the controller, and a wireless communication unit. The system further includes at least one client autonomous vehicle in wireless communication with and operated by the controller of the master autonomous vehicle and a plurality of beach cleaners, one of the plurality of beach cleaners each being attached to the master autonomous vehicle and the client autonomous vehicle.

According to another aspect, a method of cleaning a beach includes the steps of providing a master autonomous vehicle equipped with a controller, a camera in communication with the controller, a global positioning satellite unit, a ranging unit, a wireless communication unit, and a beach cleaner attached to the master autonomous vehicle, providing at least one client autonomous vehicle in wireless communication with the master autonomous vehicle and equipped with a client controller, a camera in communication with the client controller, a global positioning satellite unit, a ranging unit, a wireless communication unit, and a beach cleaner attached to the at least one client autonomous vehicle, detecting an obstacle in front of one of the master autonomous vehicle and the at least one client autonomous vehicle using the cameras and ranging units, adjusting a master route of the master autonomous vehicle to avoid the obstacle, and returning the master autonomous vehicle to the master route when the master autonomous vehicle has passed the obstacle.

According to yet another aspect, a method of cleaning a beach includes the steps of providing a master autonomous vehicle equipped with a controller, a camera in communication with the controller, a global positioning satellite unit, a ranging unit, a wireless communication unit, and a beach cleaner attached to the master autonomous vehicle, selecting a cleaning route for the master autonomous vehicle using the global positioning satellite unit of the master autonomous vehicle, and cleaning the beach along the cleaning route.

### BRIEF DESCRIPTION OF THE DRAWINGS

FIG. 1 is a side view of an autonomous vehicle for practicing the embodiments described herein.

FIG. 2 is a side view of the autonomous vehicle of FIG. 1 with an embodiment of an associated beach cleaning apparatus.

FIG. 3 is a top view of the autonomous vehicle and associated beach cleaning apparatus of FIG. 2.

FIG. 4 is a schematic view of the controller and associated electronic units of the autonomous vehicle of FIGS. 1-3.

FIG. 5 is a top view of a beach to be cleaned by the autonomous vehicle and associated beach cleaning apparatus of FIGS. 2-3.

FIG. 6 is a flowchart of a method of cleaning the beach of FIG. 5 with the autonomous vehicle and associated beach cleaning apparatus of FIGS. 2-3.

FIG. 7 is a top view of a beach to be cleaned by a system of multiple autonomous vehicles and associated beach cleaning apparatuses of FIGS. 2-3.

FIG. 8 is a flowchart of a method of cleaning the beach of FIG. 7 with the system of multiple autonomous vehicles and associated beach cleaning apparatuses of FIGS. 2-3.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

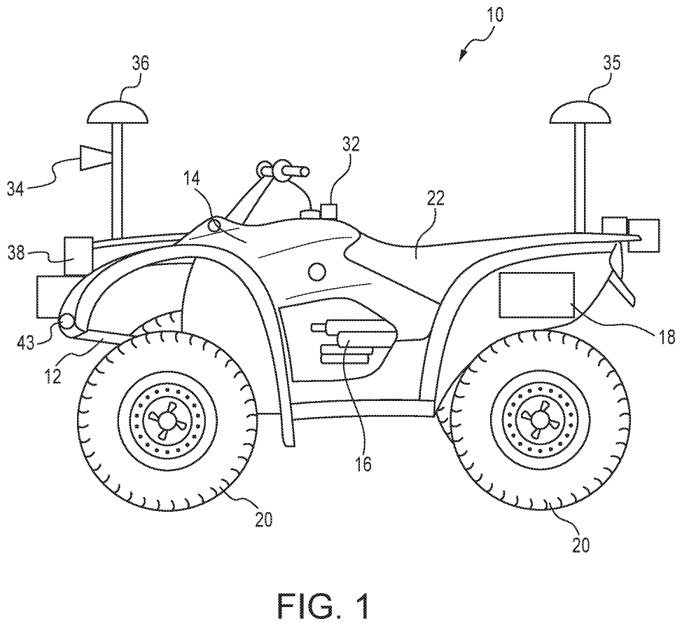

FIG. 1 is a side view of an autonomous vehicle 10 to be used as a master autonomous vehicle 10a or a client autonomous vehicle 10b according to the embodiments described herein. The autonomous vehicle 10 includes a vehicle frame 12 and a body 14 attached to the vehicle frame 12. A vehicle propulsion unit 16 may also be attached to the frame 12. The vehicle propulsion unit 16 may be a four-stroke internal combustion engine, a two-stroke internal combustion engine, an electric motor, or any other appropriate motive apparatus. In the case where the vehicle propulsion unit 16 is an internal combustion engine, the autonomous vehicle may further include a fuel tank. In the case where the vehicle propulsion unit 16 is an electric motor, as illustrated in FIG. 1, the autonomous vehicle 10 may further include a battery or battery pack 18 for storing electric charge. The autonomous vehicle 10 may further include a plurality of wheels 20, four (4) in the embodiment illustrated in FIG. 1, attached to the vehicle frame 12 and driven by the vehicle propulsion unit 16. The autonomous vehicle 10 also may include a seat 22 or a plurality of seats, one seat 22 in the embodiment illustrated in FIG. 1. The body 14 of the autonomous vehicle 10 may also be configured to hold equipment, supplies, and the like. Operation of the autonomous vehicle 10 is further described in U.S. patent application Ser. No. 15/910,832 for “Control System for Autonomous All-Terrain Vehicle (ATV),” filed Mar. 2, 2018 and U.S. patent application Ser. No. 15/915,174 for “Autonomous All-Terrain Vehicle (ATV),” filed Mar. 8, 2018, both of which are hereby incorporated by reference in their entirety.

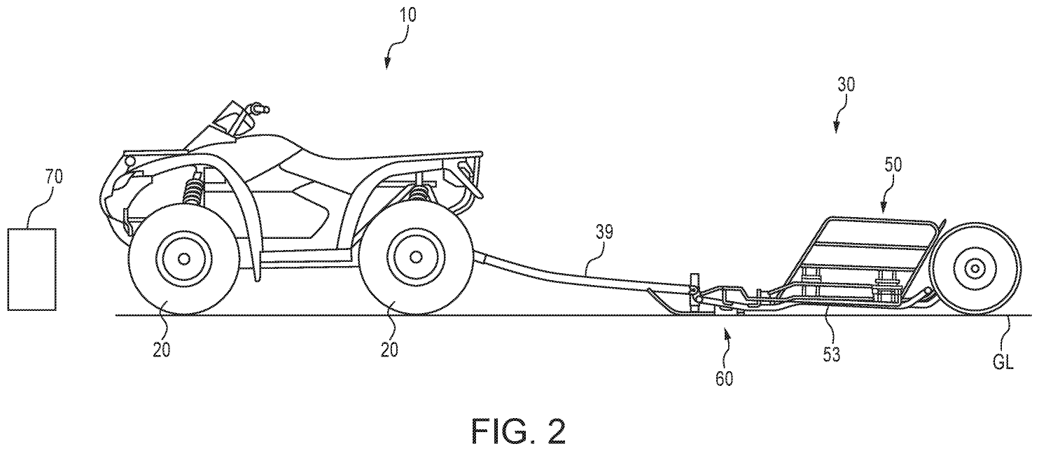

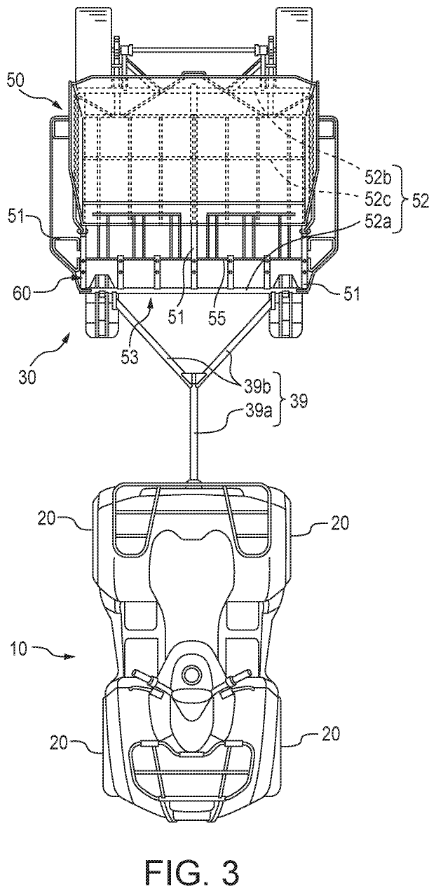

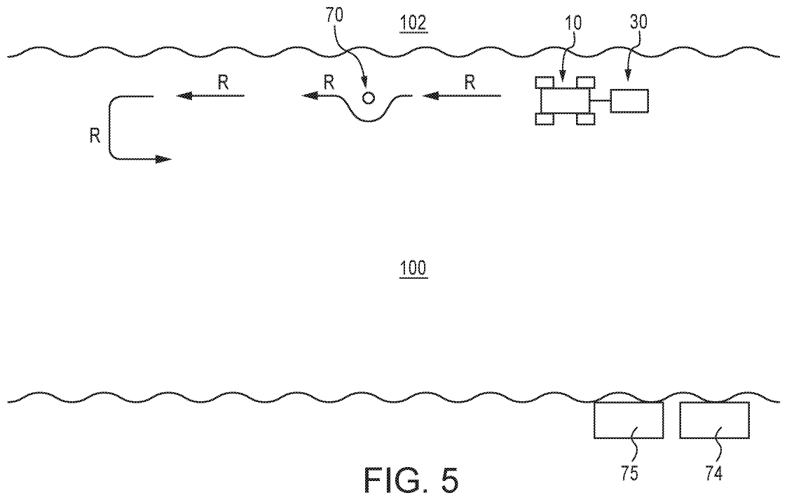

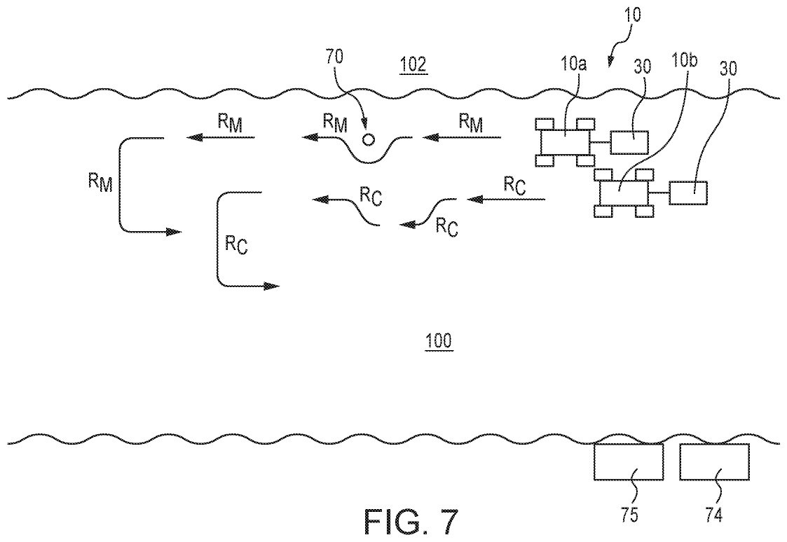

A beach cleaner 30, as illustrated in FIGS. 2 and 3, is attached to the autonomous vehicle 10, which may be pulled by the autonomous vehicle 10 to clean a sandy beach 100, illustrated in FIGS. 5 and 7. The beach cleaner 30 is designed, when pulled by the autonomous vehicle 10, to dig up and recover garbage and stones, while also minimizing the amount of sand that enters the garbage recovery unit 50. Operation of one embodiment of the beach cleaner 30 is further described in U.S. Pat. No. 9,068,308 to Ito et al. for “Beach Cleaner,” issued Jun. 30, 2015 and hereby incorporated by reference in its entirety. While one embodiment of a beach cleaner 30 is disclosed, nothing herein should limit the scope or type of beach cleaner 30 that may be used with the autonomous vehicles 10 further disclosed herein.

FIG. 2 is a left side view of a towing state of one embodiment of the beach cleaner 30. The beach cleaner 30 is constructed as a towing type so that it can be towed by the autonomous vehicle 10. The autonomous vehicle 10 is suitable for running on the sand beach 100 and has wheels 20 with relatively large diameter low-pressure balloon tires. The autonomous vehicle 10 secures a large minimum ground clearance to enhance the running performance on uneven ground.

The autonomous vehicle 10 may include a tow bar 39, and the beach cleaner 30 is connected to the tow bar 39. As shown in FIGS. 2 and 3, the beach cleaner 30 has a frame 53 formed of plural (for example, three) longitudinal members 51 extending along the vehicle running direction and lateral members 52, that is, a front lateral member 52a, a rear lateral member 52b and a middle lateral member 52c extending along the width direction (right-and-left direction) which is substantially perpendicular to the vehicle running direction. A separator 60 is provided to the front portion of the frame 53, and a garbage recovery unit 50 is provided to the rear portion of the frame 53.

During operation, the autonomous vehicle 10 and the beach cleaner 30 pick up debris from the beach 100. However, there is a limit to the size of debris that the autonomous vehicle 10 may drive over, or the beach cleaner 30 may collect, and some debris, such as large rocks or garbage that may wash on shore may be too large and must be avoided. Additionally, permanent structures or objects that need to be avoided, such as signs, posts, lifeguard stands, and the like, may be present on the beach 100. Therefore, there is established a need for a system and method such that the autonomous vehicle 10 and the beach cleaner 30, whether working as one or as a plurality, to identify and avoid hitting large or permanent obstacles 70 that would damage either the autonomous vehicle 10 or the beach cleaner 30.

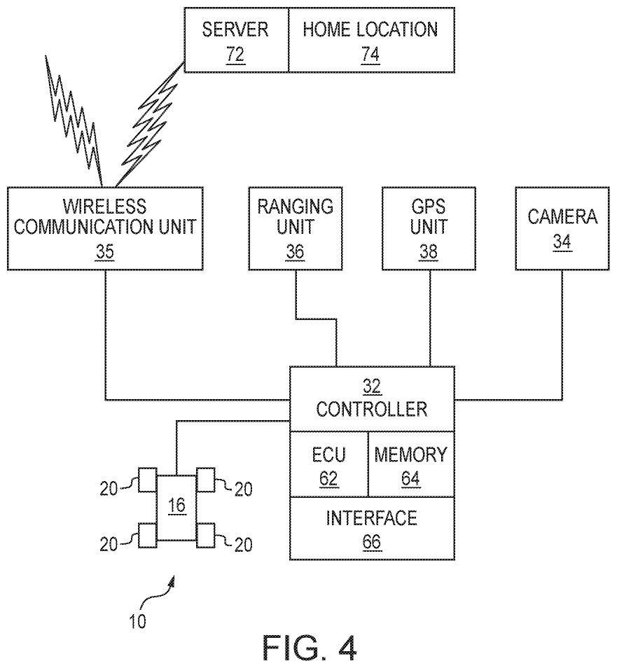

As illustrated in FIG. 1 and schematically illustrated in FIG. 4, in order to provide autonomous operation of the autonomous vehicle 10, the autonomous vehicle 10 is equipped with a controller 32, which may include an electronic control unit (“ECU”) 62, a memory 64 for storing data, and an interface 66 that may include a display, a keyboard or keypad, and any other component that would be known to a person of ordinary skill in the art.

The autonomous vehicle 10 may also be equipped with a camera 34 in communication with the controller 32. Any suitable type of camera 34 may be applied capable of supplying image data that may be analyzed by the ECU 62 for the purpose of determining the presence of an obstacle 70, shown in FIG. 2, in a route of the autonomous vehicle 10, illustrated in FIGS. 5 and 7. In one embodiment, the camera 34 may include a 360-degree field of view to identify obstacles 70 and to watch the level of debris collected by the beach cleaner 30. If the amount of debris in the beach cleaner 30 exceeds a pre-specified level, the controller 32 may direct the autonomous vehicle 10 to a debris dump station 75, as illustrated in FIGS. 5 and 7, to dump the debris before returning to cleaning the beach 100.

The autonomous vehicle 10 may further be equipped with a global positioning satellite (“GPS”) unit 38 in communication with the controller 32. The GPS unit 38 may supply location data to the ECU 62, allowing the ECU 62 to determine the exact location of the autonomous vehicle 10 on a map, which may be stored in the memory 64.

The autonomous vehicle 10 may also include a ranging unit 36, such as a LIDAR unit. The ranging unit 36 may be used to assist the ECU 62 in the identification of an obstacle 70 in the route of the autonomous vehicle 10, and upon identification of an obstacle 70, the ranging unit 36 may provide distance data to the ECU 62 regarding the distance from autonomous vehicle 10 to the obstacle 70.

The autonomous vehicle 10 may also include a wireless communication unit 35 in electrical communication with the controller 32. The wireless communication unit 35 may operate on several different communication bands, and may include multiple devices or a single device. The wireless communication unit 35 may communicate with a server 72 over a wireless network, such as a Wi-Fi network, a cellular network, or any other suitable network. The server 72 may direct the controller of the autonomous vehicle 10 to return the autonomous vehicle to the home location 74, move to another portion of the beach that requires cleaning, update weather information or tidal information to the autonomous vehicle 10, or provide any other communications that may be required. Additionally, the wireless communication unit 35 may enable the controller 32 of the autonomous vehicle 10 to communicate data to one or more additional autonomous vehicles 10, as described in greater detail below.

The autonomous vehicle 10, with the beach cleaner 30, may be programmed or otherwise instructed to clean a portion of a beach 100 or other sandy area, which may or may not border a body of water 102. In FIG. 5, the illustrated sandy beach 100 to be cleaned abuts a body of water 102. The beach 100, prior to cleaning, may include litter from beachgoers or trash deposited by tides, sea or water-based vegetation, small stones, or debris deposited on the beach 100, perhaps by wind, weather, or by other means. The beach 100 may also include obstacles 70 such as, but not limited to permanent structures, showers, lifeguard posts, posts for boardwalks, docks and associated structures, signs, sporting equipment left by beachgoers, and the like. The water 102 itself may also be considered an obstacle 70, particularly if tidal patterns are altered due to weather or other causes. What these obstacles have in common is that they could damage the autonomous vehicle 10 and/or the beach cleaner 30 should they be hit. Given the transient nature of many of these obstacles 70, programming the autonomous vehicle 10 to avoid them in advance may not be possible. The camera 34 of the autonomous vehicle 10 may be used to identify the obstacle 70. Permanent obstacles 70, such as signs, lifeguard posts, and the like, should be mapped. The position of transient obstacles 70, such as large debris, should be communicated to the home location 74 for removal by an operator, janitorial or cleaning staff, a lifeguard, or the like.

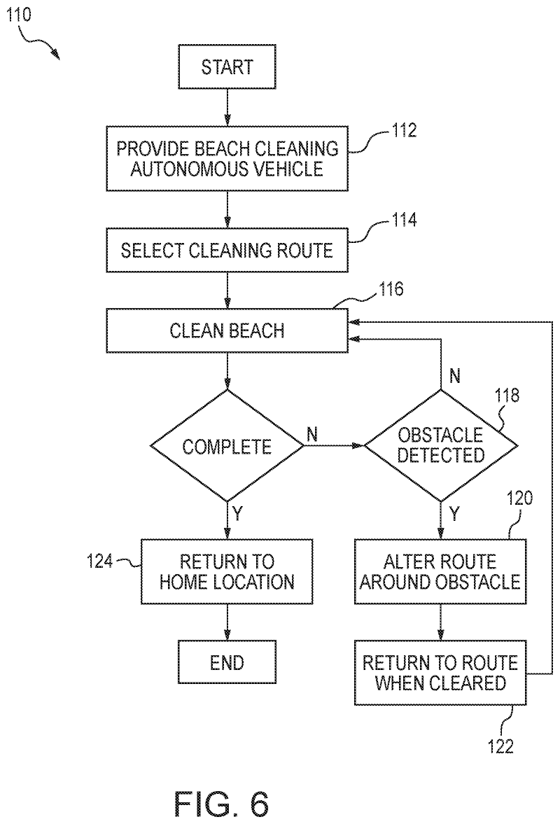

FIG. 6 is a flowchart illustrating one embodiment of a method 110 of cleaning the beach 100. In step 112, the autonomous vehicle 10 with the attached beach cleaner 30 is provided and programmed or directed to clean a specific beach 100 or portion of a beach 100. The second step 114 is selecting a cleaning route, illustrated by arrow R in FIG. 5 for the autonomous vehicle 10 using the global positioning satellite unit 38 of the autonomous vehicle 10, and the third step 116 is cleaning the beach 100 along the cleaning route R. The fourth step 118 of the method 110, if not completed, includes detecting an obstacle 70 in front of the autonomous vehicle 10 using the camera 34 and the ranging unit 36. The fifth step 120 is adjusting the cleaning route R to avoid the obstacle 70. The sixth step 122 and includes returning to the cleaning route R when the autonomous vehicle 10 has passed the obstacle 70, and the final step 124 is returning the autonomous vehicle 10 to a home location 74 when the cleaning of the beach 100 is complete.

A debris dump station 75 may also be included next to the home location 74, as illustrated in FIG. 5, or at another suitable location on the beach 100. The autonomous vehicle 10, using camera 34, may determine if debris collected by the beach cleaner 30 has accumulated to a pre-specified level. If the level exceeds the pre-specified level, the autonomous vehicle 10 may leave the cleaning route R and take the beach cleaner 30 to the debris dump station 75 to be emptied. When emptied, the autonomous vehicle 10 may then return the beach cleaner 30 to the cleaning route R at the location where it left.

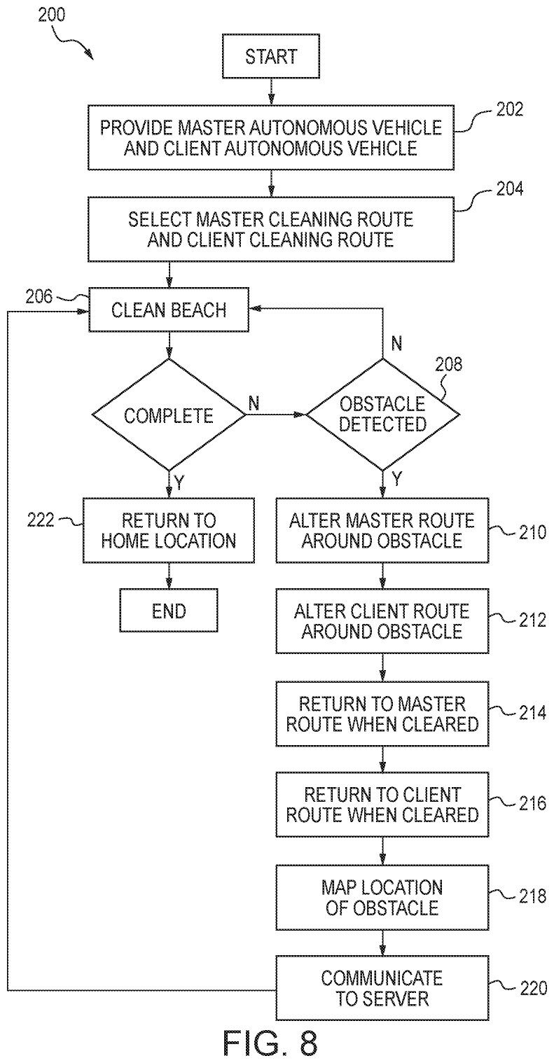

In an alternate embodiment of the method illustrated in FIGS. 7-8, a plurality of autonomous vehicles 10, each with a beach cleaner 30, may be employed to clean the beach 100. When a plurality of autonomous vehicles 10 are provided, one of the autonomous vehicles 10 is designated the master autonomous vehicle 10a, and the remaining autonomous vehicles 10 are designated client autonomous vehicles 10b. The controller 32 of the master autonomous vehicle 10a has primary responsibility for mapping the cleaning routes, shown as arrows R_{M} and R_{C} in FIG. 7, and controlling the operation of the master autonomous vehicle 10a and the client autonomous vehicles 10b. In the embodiment described herein, the client autonomous vehicles 10b are equipped with a client controller 32, a camera 34 in communication with the client controller 32, a global positioning satellite unit 38, a ranging unit 36, a wireless communication unit 35 that allows communication with the controller 32 of the master autonomous vehicle 10a through the wireless communication unit 35 of the master autonomous vehicle 10a, and a beach cleaner 30 attached to each client autonomous vehicle 10b.

The wireless communication unit 35 with each of the autonomous vehicles 10, including the master autonomous vehicle 10a and client autonomous vehicle 10b, operate under a protocol selected from the group comprising Bluetooth, BLE, ZigBee, Z-Wave, 6LoWPAN, Wi-Fi, 2G, 3G, 4G, 5G, LTE, near field communication, radio frequency identification, SigFox, LoRaWAN, Ingenu, Weightless-N, Weightless-P, Weightless-W, ANT, ANT+, DigiMesh, MiWi, EnOcean, Dash7, and WirelessHART. The controller 32 within each client autonomous vehicle 10b the associated client autonomous vehicles 10b, while the controller 32 in the master autonomous vehicle 10a makes the course decisions, speed, and the like for all of the autonomous vehicles 10 cleaning the beach 100.

FIG. 8 is a flowchart of the method 200 of operating a system with a master autonomous vehicle 10a and at least one client autonomous vehicle 10b, each with a beach cleaner 30 for cleaning the beach 100.

In the first step 202, the master autonomous vehicle 10a and the client autonomous vehicle 10b in wireless communication with the master autonomous vehicle 10a are provided. The master autonomous vehicle 10a and the client autonomous vehicle 10b, each equipped with a beach cleaner 30, are sent to clean the beach 100. The master autonomous vehicle 10a operates along a master cleaning route, depicted by arrow R_{M}, and the client autonomous vehicle 10b operate under a separate client route, depicted by arrow R_{C}, and commences the step 206 of cleaning the beach 100. In the next step 208, the obstacle 70 is detected in front of at least one of the master autonomous vehicle 10a and the client autonomous vehicle 10b using the cameras 34 and ranging units 36. In step 10, the master route of the master autonomous vehicle 10a is adjusted to avoid the obstacle 70, after which in the following step 212, the client routes of the client autonomous vehicles 10b are adjusted to avoid the obstacle 70 and the master autonomous vehicle 10a. When the obstacle 70 is passed, the master autonomous vehicle 10a returns to the master route in step 214 and then client autonomous vehicle 10b returns to the client route in step 216.

In step 218, a location of the obstacle 70 is mapped with the global positioning satellite unit 38, and in step 220, the location of the obstacle 70 is communicated to the remote server 72 at the home location 74 using the wireless communication unit 35 of the master autonomous vehicle 10a. If the obstacle 70 is a permanent structure, future cleaning routes may be adjusted to account for the obstacle. If the obstacle 70 is transient or temporary, a request to remove the obstacle 70 may be submitted. In a final step 222, the master autonomous vehicle 10a and the client autonomous vehicle 10b may be returned to the home location 74.

The debris dump station 75 may also be included next to the home location 74, as illustrated in FIG. 7, or at another suitable location on the beach 100. The master autonomous vehicle 10a and/or the client autonomous vehicle 10b, using cameras 34, may determine if debris collected by the respective beach cleaners 30 has accumulated to a pre-specified level. If the level exceeds the pre-specified level, the master autonomous vehicle 10a may leave the cleaning route R_{M} or the client autonomous vehicle 10b may leave the cleaning route R_{C} and take the associated beach cleaner 30 to the debris dump station 75 to be emptied. When emptied, the master autonomous vehicle 10a and/or the client autonomous vehicle 10b may then return the respective beach cleaners 30 to the respective cleaning routes R_{M} and R_{C} at the location where they left off.

In an embodiment where the master autonomous vehicle 10a leaves the cleaning route R_{M}, The client autonomous vehicle 10b may take the lead, and control of the system may be switched to the controller 32 of the client autonomous vehicle 10b. When the master autonomous vehicle 10a returns, control of the system may revert to the controller 32 of the master autonomous vehicle 10a, or the roles of the master autonomous vehicle 10a and the client autonomous vehicle 10b may remain exchanged until the beach 100 is cleaned or the client autonomous vehicle 10b is required to the leave cleaning route R_{C} to dump debris at the debris dump station 75.

While the embodiments are described with respect to one client autonomous vehicle 10b in operation with the one master autonomous vehicle 10a, additional client autonomous vehicles 10b, all under the control of the master autonomous vehicle 10a, may be employed.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A system for cleaning a beach, comprising:
a master autonomous vehicle, the master autonomous vehicle comprising:
a controller for operating the master autonomous vehicle;
a camera in communication with the controller for supplying image data to the controller;
a global positioning satellite unit for determining a position of the master autonomous vehicle;
a ranging unit for determining a distance to an obstacle from the master autonomous vehicle in communication with the controller; and
a wireless communication unit;
at least one client autonomous vehicle, the client autonomous vehicle in wireless communication with and operated by the controller of the master autonomous vehicle; and
a plurality of beach cleaners, one of the plurality of beach cleaners each being attached to the master autonomous vehicle and the client autonomous vehicle.

2. The system of claim 1 wherein the client autonomous vehicle comprises:
a client global positioning satellite unit for determining a position of the client autonomous vehicle; and
a client wireless communication unit for wireless communication with the wireless communication unit of the master autonomous vehicle.

3. The system of claim 2 wherein the client autonomous vehicle further comprises:
a client controller for controlling the client autonomous vehicle.

4. The system of claim 3 wherein the client controller is in wireless communication with the controller of the master autonomous vehicle via the wireless communication unit and the client wireless communication unit.

5. The system of claim 4 wherein the client autonomous vehicle further comprises:
a client camera in communication with the client controller for supplying image data to the client controller; and
a client ranging unit for determining a distance to the obstacle from the client autonomous vehicle in communication with the client controller.

6. The system of claim 1 wherein the image data of the camera comprises an image of the obstacle.

7. The system of claim 6 wherein:
the controller directs the master autonomous vehicle change a course to avoid the obstacle; and
the controller directs the client autonomous vehicle to change a client course to avoid the master autonomous vehicle and the obstacle.

8. The system of claim 1 comprising:
a plurality of client autonomous vehicles.

9. A method of cleaning a beach comprising the steps of:
providing a master autonomous vehicle equipped with a controller, a camera in communication with the controller, a global positioning satellite unit, a ranging unit, a wireless communication unit, and a beach cleaner attached to the master autonomous vehicle;
providing at least one client autonomous vehicle in wireless communication with the master autonomous vehicle and equipped with a client controller, a camera in communication with the client controller, a global positioning satellite unit, a ranging unit, a wireless communication unit, and a beach cleaner attached to the at least one client autonomous vehicle;
detecting an obstacle in front of one of the master autonomous vehicle and the at least one client autonomous vehicle using the cameras and ranging units;
adjusting a master route of the master autonomous vehicle to avoid the obstacle; and
returning the master autonomous vehicle to the master route when the master autonomous vehicle has passed the obstacle.

10. The method of claim 9 further comprising the steps of:
adjusting a client route of the client autonomous vehicle to avoid the obstacle and the master autonomous vehicle; and
returning the client autonomous vehicle to the client route when the client autonomous vehicle has passed the obstacle and the master autonomous has returned to the master route.

11. The method of claim 10 further comprising the steps of:
mapping a location of the obstacle with the global positioning satellite unit; and
communicating the location of the obstacle to a remote server at a remote location using the wireless communication unit.

12. A method of cleaning a beach comprising the steps of:
providing a master autonomous vehicle equipped with a controller, a camera in communication with the controller, a global positioning satellite unit, a ranging unit, a wireless communication unit, and a beach cleaner attached to the master autonomous vehicle;
selecting a cleaning route for the master autonomous vehicle using the global positioning satellite unit of the master autonomous vehicle; and
cleaning the beach along the cleaning route.

13. The method of claim 12 further comprising the steps of:
detecting an obstacle in front of the master autonomous vehicle using the camera and the ranging unit;
adjusting the cleaning route to avoid the obstacle; and
returning to the cleaning route when the master autonomous vehicle has passed the obstacle.

14. The method of claim 13 further comprising the step of:
returning the master autonomous vehicle to a home location when the beach is cleaned.

15. The method of claim 12 further comprising the steps of:
providing at least one client autonomous vehicle in wireless communication with the master autonomous vehicle and equipped with a client controller, a camera in communication with the client controller, a global positioning satellite unit, a ranging unit, a wireless communication unit, and a beach cleaner attached to the at least one client autonomous vehicle;
selecting a client cleaning route for the at least one client autonomous vehicle using the global positioning satellite unit of the master autonomous vehicle; and
cleaning the beach along the client cleaning route with the at least one client autonomous vehicle.

16. The method of claim 15 further comprising the steps of:
detecting an obstacle in front of one of the master autonomous vehicle and the at least one client autonomous vehicle using the cameras and ranging units;
communicating a location of the obstacle between the master autonomous vehicle and the at least one client autonomous vehicle.

17. The method of claim 16 further comprising the steps of:
adjusting the cleaning route of the master autonomous vehicle to avoid the obstacle; and
returning the master autonomous vehicle to the cleaning route when the master autonomous vehicle has passed the obstacle.

18. The method of claim 17 further comprising the steps of:
adjusting the client cleaning route of the at least one client autonomous vehicle to avoid the obstacle; and
returning the at least one client autonomous vehicle to the client cleaning route when the at least one client autonomous vehicle has passed the obstacle.

19. The method of claim 18 further comprising the step of:
returning the at least one client autonomous vehicle to the home location when the beach is cleaned.

20. The method of claim 19 further comprising the steps of:
mapping a location of the obstacle with the global positioning satellite unit; and
communicating the location of the obstacle to a remote server at a remote location using the wireless communication unit.
